(19) United States
(12) Patent Application Publication
(10) Pub. No.: US 2025/0317217 A1
(43) Pub. Date: Oct. 9, 2025

(54) OPTICAL COMMUNICATION SYSTEM, OPTICAL NODE, AND OPTICAL POWER SUPPLY METHOD

(71) Applicant: NIPPON TELEGRAPH AND TELEPHONE CORPORATION, Tokyo (JP)

(72) Inventors: Tomohiro KAWANO, Musashino-shi, Tokyo (JP); Akihiro KURODA, Musashino-shi, Tokyo (JP); Hidenobu HIROTA, Musashino-shi, Tokyo (JP); Kazuhide NAKAE, Musashino-shi, Tokyo (JP); Hiroshi WATANBE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/864,871

(22) PCT Filed: May 27, 2022
(86) PCT No.: PCT/JP2022/021668

§ 371 Date: Nov. 11, 2024

(51) Int. Cl. H04B 10/80; H04B 10/25

(52) U.S. Cl. CPC H04B 10/807; H04B 10/25

(57) ABSTRACT

An object of the present invention is to provide an optical communication system, an optical node, and an optical power feeding method capable of avoiding a loss of stored energy of each optical node.

In an optical communication system 301 according to the present invention, a plurality of optical nodes (1-1, 1-2, 1-3, . . . ) is connected in series by optical fibers 2 in a downstream direction from an upstream controller 13, and the controller 13 performs optical power feed to each of the optical nodes (1-1, 1-2, 1-3, . . . ). The controller 13 inputs, to the optical fiber 2-0, wavelength multiplexed light beam obtained by multiplexing light beams of different wavelengths for each optical node 1. The optical node 1 includes an optical branching unit (wavelength filter 23) that branches and extracts a light beam having a wavelength allocated to the optical node from a wavelength multiplexed light beam from the upstream side, and outputs the wavelength multiplexed light beams including other wavelengths to the downstream side, and a photoelectric conversion unit (photoelectric conversion element 24 or 30) that charges a storage battery (26 or 27) with the light beam of the wavelength branched by the optical branching unit.

### TECHNICAL FIELD

The present disclosure relates to an optical communication system that performs optical power feed to an optical node, the optical node, and an optical power feeding method thereof.

### BACKGROUND ART

In an optical fiber network, particularly, an access network connecting a communication company and an optical terminal, optical path switching for connecting optical fiber core wires to any route or changing a route is performed at a constant frequency in order to efficiently use equipment in opening and maintenance of the optical fiber network. While such work is normally performed by going to a site to physically change the connection, a technique of remotely performing the work by using an optical switch has been proposed.

For example, Non Patent Literature 1 reports a technique in which a communication building equipped with a laser and a plurality of optical nodes that remotely operates optical switches are connected by a single optical fiber and controlled. The optical node is equipped with a self-holding optical switch, and one laser enables optical power feed to the plurality of optical nodes and communication with the optical nodes.

### CITATION LIST

### Non Patent Literature

Non Patent Literature 1: Tomohiro Kawano, Tetsuya Manabe, Akihiro Kuroda, Kazuhide Nakae, Hiroshi Watanabe, and Kazunori Katayama, “Enkaku kouro kirikae node no chokuretsu setsuzoku houshiki ni kansuru ichi kento (in Japanese) (a study on series connection system of remote operated optical fiber switching nodes)” The Institute of Electronics, Information and Communication Engineers General Conference 2022, B-13-28

### SUMMARY OF INVENTION

### Technical Problem

However, in the system described in Non Patent Literature 1, when the stored energy of the optical node disappears for some reason, the above-described optical switch control cannot be performed, and there is a problem of having a difficulty in performing optical power feed and communication with the optical node.

Therefore, to solve the above problem, an object of the present invention is to provide an optical communication system, an optical node, and an optical power feeding method capable of avoiding a loss of stored energy of each optical node.

### Solution to Problem

To achieve the above object, an optical communication system according to the present invention enables differentiation of a wavelength of optical power feed to each optical node and simultaneous optical power feed to all the optical nodes.

Specifically, an optical communication system according to the present invention is an optical communication system in which a plurality of optical nodes is connected in series by an optical fiber in a downstream direction from an upstream controller, and the controller performs optical power feed to the optical nodes, in which
the controller inputs, to the optical fiber, a wavelength multiplexed light beam obtained by multiplexing light beams having different wavelengths for each of the optical nodes, and
the optical node includes:
an optical branching unit that branches and extracts a light beam having a wavelength allocated to the optical node from the wavelength multiplexed light beam from an upstream side, and outputs the wavelength multiplexed light beam having another wavelength to a downstream side; and
a photoelectric conversion unit that charges a storage battery with the light beam having the wavelength branched by the optical branching unit.

Further, an optical node according to the present invention is an optical node of a plurality of the optical nodes connected in series by an optical fiber in a downstream direction from an upstream controller, and configured to receive optical power feed from the controller, the optical node including:
an optical branching unit that branches and extracts a light beam having a wavelength allocated to the optical node from a wavelength multiplexed light beam obtained by multiplexing light beams having different wavelengths for the each optical node input to the optical fiber by the controller, and outputs the wavelength multiplexed light beam having another wavelength to a downstream side; and
a photoelectric conversion unit that charges a storage battery with the light beam having the wavelength branched by the optical branching unit.

Moreover, an optical power feeding method according to the present invention is an optical power feeding method performed from an upstream controller to an optical node in an optical communication system in which a plurality of the optical nodes is connected in series by an optical fiber in a downstream direction from the controller, the optical power feeding method including:
in each of the optical nodes,
branching and extracting a light beam having a wavelength allocated to the optical node from a wavelength multiplexed light beam obtained by multiplexing light beams having different wavelengths for the each optical node input to the optical fiber by the controller, and outputting the wavelength multiplexed light beam having another wavelength to a downstream side; and
charging a storage battery of the optical node with the light beam having the wavelength allocated to the optical node.

The controller transmits, to the optical fiber, the wavelength multiplexed light beam obtained by multiplexing light beams of different wavelengths for each optical node. An exclusive specific wavelength is set to each optical node. Each optical node extracts the light beam having the wavelength set to the optical node from the wavelength multiplexed light beam transmitted from the upstream side of the optical fiber using a wavelength filter and uses the light beam for optical power feed. Therefore, the controller can simultaneously perform the optical power feed to all the optical nodes.

Therefore, the present invention can provide an optical communication system, an optical node, and an optical power feeding method capable of avoiding a loss of stored energy of each optical node.

In addition, in the case of the system of Non Patent Literature 1, logical connection between the communication building and the optical node is one-to-one, and thus communication with other nodes cannot be performed during communication with a certain optical node, and there is also a problem of having a difficulty in managing excess or deficiency of optical power feed to all the optical nodes.

Furthermore, in the case of the system of Non Patent Literature 1, there is also a problem of having a difficulty in improving the efficiency of optical power feed because other optical nodes cannot be constantly monitored while communicating with a certain optical node.

The optical node according to the optical communication system according to the present invention further includes a control unit that grasps a power storage status of the storage battery and notifies the controller to adjust light intensity of the light beam having the wavelength allocated to the optical node.

Further, the optical node of the optical communication system according to the present invention further includes an optical receiver that receives the light beam having the wavelength allocated to the optical node and modulated by the controller, and a modulation unit that modulates the light beam having the wavelength allocated to the optical node on a basis of the notification and transmits the modulated light beam to the controller.

In the case of the present optical communication system, since the wavelength multiplexed light beam is used, the controller can simultaneously communicate with all the optical nodes by modulating the wavelength multiplexed light beam. Therefore, the present optical communication system can constantly monitor all the optical nodes, and can manage excess or deficiency of optical power feed. In particular, the energy efficiency can be improved by increasing light intensity of the wavelength to the optical node in which the stored energy is reduced and decreasing the light intensity of the wavelength to the optical node in which the stored energy is sufficient.

The optical node of the optical communication system according to the present invention includes two of the storage batteries, one of the storage batteries is for a load, and the other of the storage batteries is for the control unit.

In a case where the load of the optical node requires high power, there is a possibility that a voltage drop of the storage battery occurs and a failure occurs in the operation of the control unit. Therefore, by separating the storage battery for the load and the storage battery for the control unit, it is possible to avoid an operation failure of the control unit even when the load requires high power.

Note that the above-described inventions can be combined as much as possible.

### Advantageous Effects of Invention

The present invention can provide an optical communication system, an optical node, and an optical power feeding method capable of avoiding a loss of stored energy of each optical node.

According to the present invention, by preparing a corresponding number of lasers for a plurality of optical nodes and multiplexing and transmitting the lasers, an optical power feeding function and an optical communication function can be simultaneously implemented for the plurality of optical nodes by a single optical fiber, and communication with the optical nodes can be performed at any timing, so that a highly reliable optical communication system can be provided.

In addition, it is possible to control an optimum optical power feed amount by constantly monitoring and grasping the storage amount of the optical node, and it is possible to provide an optical communication system capable of remotely and efficiently performing power feed.

### BRIEF DESCRIPTION OF DRAWINGS

FIG. 1 is a diagram for describing a configuration of an optical communication system and optical nodes according to the present invention.

FIG. 2 is a flowchart for describing an optical power feeding method according to the present invention.

FIG. 3 is a graph for describing a voltage curve by charging of a storage battery.

### DESCRIPTION OF EMBODIMENTS

Embodiments of the present invention will be described with reference to the accompanying drawings. The embodiments to be described below are examples of the present invention, and the present invention is not limited to the embodiments to be described below. Note that components having the same reference numerals in the present specification and the drawings indicate the same components.

### First Embodiment

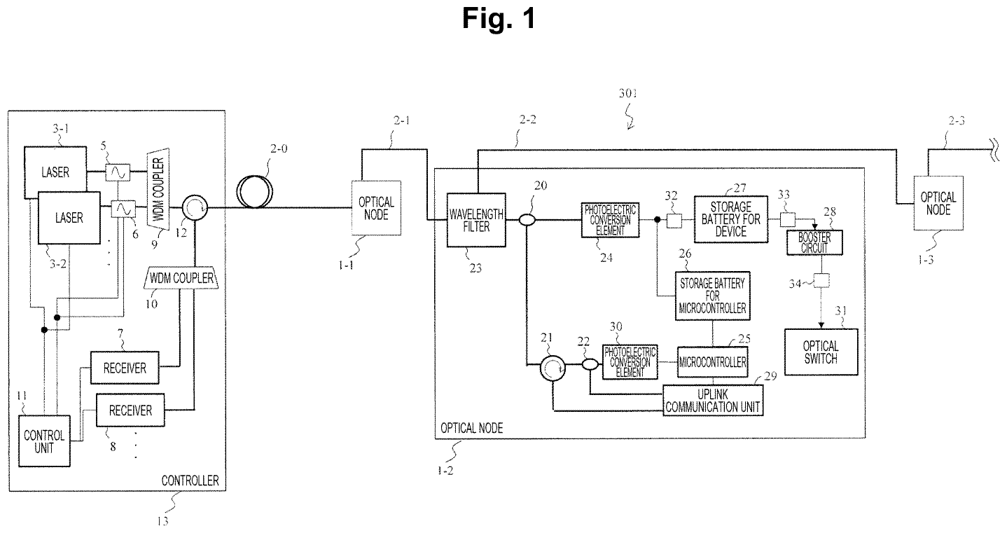

FIG. 1 is a diagram for describing a configuration of an optical communication system 301 and optical nodes 1 according to the present invention.

In the optical communication system 301, a plurality of optical nodes (1-1, 1-2, 1-3, . . . ) is connected in series by optical fibers 2 in a downstream direction from an upstream controller 13, and the controller 13 performs optical power feed to each of the optical nodes (1-1, 1-2, 1-3, . . . ).

Note that, in the present specification, when individual optical nodes are described, they are distinguished by being denoted by reference numerals of 1-1, 1-2, 1-3, . . . , and the like, and when content common to all the optical nodes is described, they are described as “optical node(s) 1”. Similarly, when individual optical fibers are described, they are distinguished by being denoted by reference numerals of 2-0, 2-1, 2-2, 2-3, . . . , and the like, and when content common to all the optical fibers is described, they are described as “optical fiber(s) 2”.

In addition, in the present specification, a direction of the controller 13 is referred to as “upstream”, and a direction toward the optical node 1-1, the optical node 1-2, the optical nodes 1-3, . . . is referred to as “downstream”.

The controller 13 inputs, to the optical fiber 2-0, wavelength multiplexed light beam obtained by multiplexing light beams of different wavelengths for each optical node 1.

Specifically, the controller 13 includes a control unit 11, a first power feed laser 3-1 that outputs a light beam having a first wavelength, a second power feed laser 3-2 that outputs a light beam having a second wavelength different from the first wavelength, a first modulator 5 that modulates the light beam of the first power feed laser 3-1, a second modulator 6 that modulates the light beam of the second power feed laser 3-2, an optical circulator 12, a first optical receiver 7, a second optical receiver 8, a WDM coupler 9 that multiplexes a downlink signal, and a WDM coupler 10 that demultiplexes an uplink signal. The controller 13 is installed in a communication building where a power supply can be secured. Laser beams emitted from the first power feed laser 3-1 and the second power feed laser 3-2 are input to the optical fiber 2-0 via the WDM coupler 9 and the optical circulator 12.

In FIG. 1, the number of power feed lasers is two, but the number of power feed lasers is increased or decreased according to the number of optical nodes.

The optical node 1 is installed in, for example, a place where no power supply is available. The respective optical nodes 1 are connected in series from the controller 13 by the optical fibers (2-0, 2-1, 2-2, 2-3, . . . ). As described above, the optical communication system 301 has a configuration in which the plurality of optical nodes 1 is connected in series to one controller device 13 via the optical fibers 2.

The optical node 1 includes:
an optical branching unit (wavelength filter 23) that branches and extracts a light beam having a wavelength allocated to the optical node from the wavelength multiplexed light beam from the upstream side, and outputs the wavelength multiplexed light beams including other wavelengths to the downstream side; and
a photoelectric conversion unit (photoelectric conversion element 24 or 30) that charges a storage battery (26 or 27) with the light beam of the wavelength branched by the optical branching unit.

The optical node 1 extracts only the light beam having the wavelength allocated to the optical node from the wavelength multiplexed downlink light beams from the optical fiber 2 by the wavelength filter 23, converts the light beam into power by the photoelectric conversion element, and stores the power in the storage battery. Then, drive power is supplied from the storage battery to all of active elements (an optical switch 31 and the like) included in the optical node.

The optical branching unit 20 is a branching ratio coupler having, for example, a branching ratio of 90:10 or 99:1, and branches more optical power into the photoelectric conversion element 24 for power feed. The photoelectric conversion element 24 includes an element suitable for a long wavelength of 1300 nm to 1600 nm for communication, for example, the element containing indium gallium arsenide. As the photoelectric conversion element, a photoelectric conversion element having an open voltage of 5 V or less and conversion efficiency of about 30% can be easily obtained. Therefore, the wavelength of the light beam output from each laser of the controller 13 is set to a wavelength corresponding to the photoelectric conversion element.

The device storage battery 27 stores power energy converted by the photoelectric conversion element 24. The device storage battery 27 is, for example, an electric double layer capacitor or the like. In voltage supply to each active element, a supply voltage is appropriately adjusted by a booster circuit 28 (DC/DC converter or the like).

The light beam having small optical power branched by the optical branching unit 20 is guided to an optical branching unit 22 via an optical circulator 21, and is input to the photoelectric conversion element 30 for receiving an optical signal and an uplink communication unit 29. The photoelectric conversion element 30 receives a control signal from the controller 13. The uplink communication unit 29 is an optical switch capable of controlling ON/OFF as to whether to attenuate a part of the downlink light beam, and modulates an uplink communication light beam toward the controller 13. The uplink communication unit 29 desirably operates at a low voltage and with very small power consumption of several nanowatts (nW) or less, and for example, a generally available electrostatically driven MEMS optical switch that requires less drive power can be used.

The optical node 1 has a microcontroller 25 for control. The microcontroller 25 mainly has four functions (1) to (4).

### (1) Downlink Frame Analysis Function

The microcontroller 25 analyzes a downlink frame included in the downlink light beam from the controller 13 received by photoelectric conversion element 30. The frame includes a request for node information, an execution instruction related to switching, and the like.

### (2) Uplink Signal Generation Function

The microcontroller 25 modulates the uplink communication unit 29 to generate an uplink signal light beam in cooperation with the downlink frame analysis function.

### (3) Optical Switch Operation Control Function

The microcontroller 25 reads an instruction from the controller 13 and operates an optical switch 31 for switching a communication service, for example, in cooperation with the downlink frame analysis function.

### (4) Power Monitoring Function

The microcontroller 25 monitors an amount of stored energy in the storage battery 27. The microcontroller 25 constantly grasps the amount of stored energy of the storage battery 27 via a voltage monitor or the like, and notifies the controller 13 via the signal generation function on the basis of a set threshold.

As described above, the microcontroller 25 causes the four functions to cooperate with each other, thereby allowing the optical node itself to manage the amount of stored energy, communicate with the controller 13, and receive the execution instruction from the controller 13.

The optical node 1 includes two storage batteries, and favorably, one (storage battery 27) of the storage batteries is used for the load (the active element such as the optical switch 31), and the other (storage battery 26) of the storage batteries is used for the control unit (the microcontroller 25 and the uplink communication unit 29).

The optical node 1 includes the microcontroller storage battery 26 for driving the microcontroller 25 and the uplink communication unit 29 separately from the device storage battery 27. In the case where the electric double layer capacitor is used as the storage battery 27, there is a characteristic that a voltage drop occurs due to an influence of an internal resistance when a large current is output, and there is a possibility that the microcontroller 25 is reset at that time. To avoid resetting the microcontroller 25, it is favorable to divide the storage battery into a storage battery for the microcontroller 25 and a storage battery for the optical switch 31. The optical switch 31 can control which storage battery (26 or 27) is to be charged by a load switch A 32.

Furthermore, since the optical node 1 needs to be driven with minute power, for example, the power is supplied to drive the booster circuit 28 and the optical switch 31 only when necessary. Therefore, the optical switch 31 includes a load switch B 33 and a load switch C 34. The booster circuit 28 is driven only when the load switch B 33 is ON. Each load switch is disposed on a power feed line from the device storage battery 27 such that the optical switch 31 is driven only when the load switch C 34 is ON. By adopting this configuration, wasteful power consumption can be avoided.

### Second Embodiment

In the present embodiment, the above-described power monitoring function will be mainly described.

A microcontroller 25 of an optical node 1 grasps a power storage status of a storage battery 27 and notifies a controller 13 to adjust light intensity of a light beam having a wavelength allocated to the optical node.

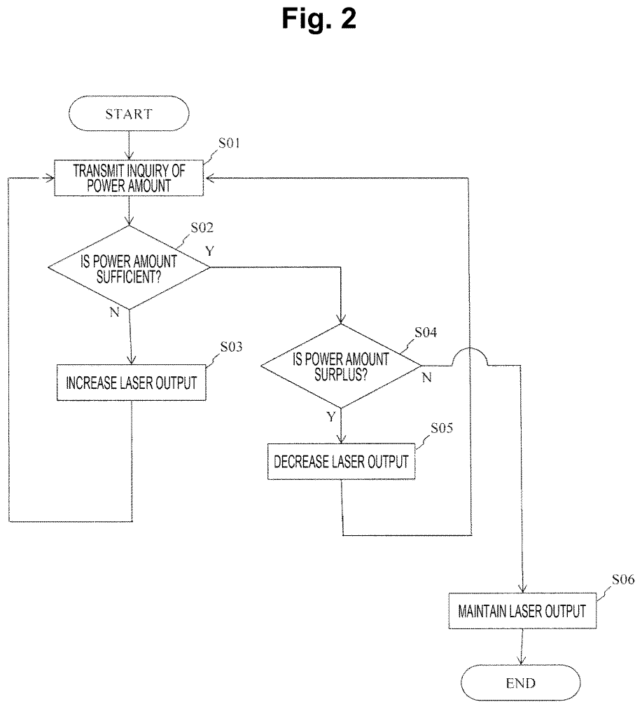

FIG. 2 is a flowchart for describing the power monitoring function.

A control unit 11 of the controller 13 monitors and grasps a storage amount of each optical node 1 by a storage amount inquiry (step S01). Here, in a case where a power amount of the device storage battery 27 of an arbitrary optical node 1-x (x is 1, 2, 3, . . . ) is insufficient to operate an optical switch 31 (“No” in step S02), the control unit 11 increases an output of a power feed laser 3-x corresponding to the optical node 1-x within a range of an upper limit of the light intensity that can be input to an optical fiber 2 (step S03).

In addition, in a case where the power amount of the device storage battery 27 of the arbitrary optical node 1-x (x is 1, 2, 3, . . . ) is not insufficient (“Yes” in step S02) and there is a surplus (“Yes” in step S04), the control unit 11 decreases the output of the power feed laser 3-x corresponding to the optical node 1-x (step S05). Otherwise (“No” in step S04), the control unit 11 maintains the output of the power feed laser corresponding to the optical node (step S06).

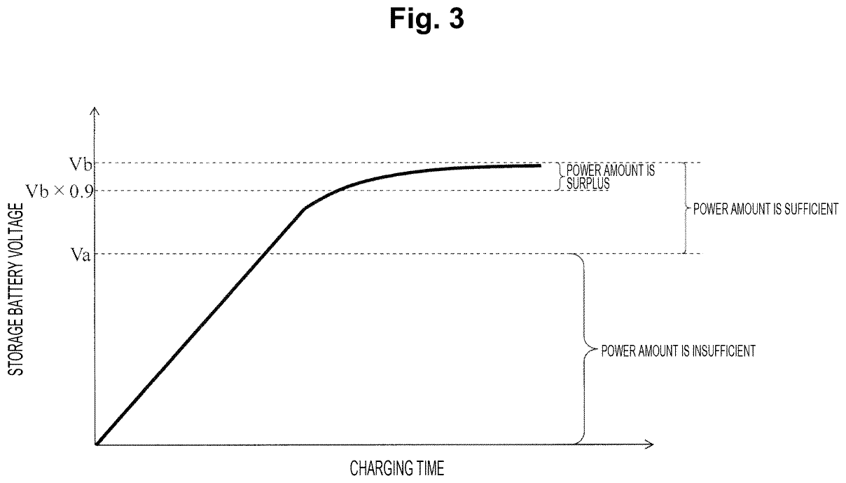

Here, excess or deficiency of the power amount of a device storage battery 27 will be described. FIG. 3 is a graph for describing a voltage curve by charging of the device storage battery 27. As illustrated in FIG. 3, when charging is started when the power amount of the device storage battery 27 is 0, an output voltage of the storage battery 27 approaches an output voltage Vb of a photoelectric conversion element 24 as close as possible via a voltage Va at which the optical switch 31 can be operated. However, as the output voltage of the storage battery 27 approaches the output voltage of the photoelectric conversion element 24, an increase rate of the voltage decreases.

For example, as illustrated in FIG. 3, a state in which the output voltage of the storage battery 27 is higher than the voltage Va at which the optical switch can be operated is referred to as a “state in which the power amount is sufficient”, and a state in which the output voltage of the storage battery 27 is close to the output voltage Vb of the photoelectric conversion element 24, for example, a state at a voltage value of 90% of the output voltage Vb of the photoelectric conversion element 24 is referred to as a “state in which the power amount is surplus”. In addition, a state in which the output voltage of the storage battery 27 is lower than the voltage Va at which the optical switch can be operated is referred to as a “state in which the power amount is insufficient”.

As described above, the excess or deficiency of the power amount of the device storage battery 27 is determined and notified to the controller 13, whereby the output of the power feed laser is adjusted by the control unit 11, and optimal power feed to the optical node 1 can be performed. The excess or deficiency of the storage battery may be similarly applied to the microcontroller storage battery 26.

### Effects

As described in the above embodiments, the optical communication system according to the present invention transmits a plurality of downlink laser beams supplied from the controller 13 to each optical node 1 through the single path (optical fiber 2), and uses the optical power of the laser light beam not only as the power for power feed to each optical node 1, but also for both the power management of each optical node 1 and the control of the optical switch 31 of the node as the control signal for the node by simultaneously modulating intensity in a time domain. Therefore, the present invention can provide a highly reliable optical node system that can simultaneously implement the functions of optical power feed and optical switch control for a plurality of optical nodes in a single path. In addition, since a unique wavelength is allocated to each optical node and each optical node includes the wavelength filter that extracts the wavelength, it is possible to operate each optical node. Therefore, expansion such as increasing the number of optical nodes included in the system is easy.

In addition, since the wavelengths of the light beams transmitted to the plurality of optical nodes are different from each other, the uplink signals emitted to the communication building side are not interfered, and can be received at arbitrary timing. Therefore, for example, it is possible to quickly respond to an alarm from the optical node, and it is possible to provide an optical node system having responsiveness.

Moreover, the laser output of the optical power feed light beam supplied to each optical node is individually variable according to the storage amount of the optical node and the necessity of the optical switch operation. For this reason, it is possible to suppress the power amount of the power feed light laser beam inside a facility by suppressing the output of the laser corresponding to the optical node having a small power consumption amount, and it is possible to rapidly charge the optical node having a small power storage amount by increasing the power feed laser output and quickly respond to an optical switch operation request or the like.

Reference Signs List

| | |
|---|---|
| 1, 1-1, 1-2, | Optical node |
| 1-3, . . . | |
| 2, 2-0, 2-1, | Optical fiber |
| 2-2, 2-3, . . . | |
| 3-1, 3-2, . . . | Power feed laser |
| 5 | First modulator |
| 6 | Second modulator |
| 7 | First optical receiver |
| 8 | Second optical receiver |
| 9 | WDM coupler |
| 10 | WDM coupler |
| 11 | Control unit |
| 12 | Optical circulator |
| 13 | Controller |
| 20 | Optical coupler |
| 21 | Optical circulator |
| 22 | Optical coupler |
| 23 | Wavelength filter |
| 24 | Photoelectric conversion element |
| 25 | Microcontroller |
| 26 | Microcontroller storage battery |
| 27 | Device storage battery |
| 28 | Booster circuit |
| 29 | Uplink communication unit |
| 30 | Photoelectric conversion element |
| 31 | Optical switch |
| 32 | Load switch A |
| 33 | Load switch B |
| 34 | Load switch C |
| 301 | Optical communication system |

1. An optical communication system in which a plurality of optical nodes is connected in series by an optical fiber in a downstream direction from an upstream controller, and the controller performs optical power feed to the optical nodes, wherein
the controller inputs, to the optical fiber, a wavelength multiplexed light beam obtained by multiplexing light beams having different wavelengths for each of the optical nodes, and
the optical node includes:
an optical branching unit that branches and extracts a light beam having a wavelength allocated to the optical node from the wavelength multiplexed light beam from an upstream side, and outputs the wavelength multiplexed light beam having another wavelength to a downstream side; and
a photoelectric conversion unit that charges a storage battery with the light beam having the wavelength branched by the optical branching unit.

2. The optical communication system according to claim 1, wherein the optical node further includes a control unit that grasps a power storage status of the storage battery and notifies the controller to adjust light intensity of the light beam having the wavelength allocated to the optical node.

3. The optical communication system according to claim 2, wherein the optical node includes two of the storage batteries, one of the storage batteries is for a load, and the other of the storage batteries is for the control unit.

4. The optical communication system according to claim 2, wherein
the optical node further includes:
an optical receiver that receives the light beam having the wavelength allocated to the optical node and modulated by the controller; and
a modulation unit that modulates the light beam having the wavelength allocated to the optical node on a basis of the notification and transmits the modulated light beam to the controller.

5. An optical node of a plurality of the optical nodes connected in series by an optical fiber in a downstream direction from an upstream controller, and configured to receive optical power feed from the controller, the optical node comprising:
an optical branching unit that branches and extracts a light beam having a wavelength allocated to the optical node from a wavelength multiplexed light beam obtained by multiplexing light beams having different wavelengths for the each optical node input to the optical fiber by the controller, and outputs the wavelength multiplexed light beam having another wavelength to a downstream side; and
a photoelectric conversion unit that charges a storage battery with the light beam having the wavelength branched by the optical branching unit.

6. An optical power feeding method performed from an upstream controller to an optical node in an optical communication system in which a plurality of the optical nodes is connected in series by an optical fiber in a downstream direction from the controller, the optical power feeding method comprising:
in each of the optical nodes,
branching and extracting a light beam having a wavelength allocated to the optical node from a wavelength multiplexed light beam obtained by multiplexing light beams having different wavelengths for the each optical node input to the optical fiber by the controller, and outputting the wavelength multiplexed light beam having another wavelength to a downstream side; and
charging a storage battery of the optical node with the light beam having the wavelength allocated to the optical node.
